(19) United States
(12) Patent Application Publication
(10) Pub. No.: US 2019/0233965 A1
(43) Pub. Date: Aug. 1, 2019

(54) CATALYST PRODUCTION

(71) Applicants: Guang-Lin Zhao, Baton Rouge, LA (US); Kuo Li, Austin, TX (US); Maryam Jahan, Baton Rouge, LA (US)

(72) Inventors: Guang-Lin Zhao, Baton Rouge, LA (US); Kuo Li, Austin, TX (US); Maryam Jahan, Baton Rouge, LA (US)

(21) Appl. No.: 16/253,618

(22) Filed: Jan. 22, 2019

Related U.S. Application Data
(60) Provisional application No. 62/794,311, filed on Jan. 18, 2019.
(60) Provisional application No. 62/622,666, filed on Jan. 26, 2018.

(51) Int. Cl. C25D 13/02; C01B 32/194; C01B 32/168

(52) U.S. Cl. CPC C25D 13/02; B82Y 30/00; C01B 32/168; C01B 32/194

(57) ABSTRACT

Electrocatalytic methods are disclosed that may include preparing a catalyst ink with nano-structured or micro-structured electrocatalyst particles, casting the catalyst ink onto an electrode and drying the catalyst ink while subjecting the catalyst ink to an electrical field. Electrochemical reactions may then be carried out using the modified electrode as an electrocatalyst.

This application claims the benefit of U.S. Provisional Application No. 62/622,666 filed Jan. 26, 2018 entitled Catalyst Production and U.S. Provisional Application No. 62/794,311 filed Jan. 18, 2019 entitled Catalyst Production both of which are incorporated herein by reference.

This invention was made with government support under Award No W911NF-15-1-0483 awarded by the Army Research Office, under Award No. FA9550-09-1-0367 awarded by the Air Force Office of Scientific Research and Award No 1736136 awarded by the National Science Foundation. The government has certain rights in the invention.

Methods of catalyst production described herein may be used in the production of catalyst. Certain methods of catalyst production disclosed herein may produce effective electrocatalysts for oxygen reduction reaction and other applications.

### BRIEF DESCRIPTION OF THE FIGURES

FIG. 1 is a transmission electron microscopy image of a PNGs sample.

FIG. 2A is a scanning electron microscopy, image of a dried PNGs electrode dried without an electrical field.

FIG. 2B is a scanning electron microscopy image of a dried PNGs electrode dried with an electrical field.

FIG. 2C is a scanning electron microscopy image of a dried PNGs electrode dried without an electrical field.

FIG. 2D is a scanning electron microscopy image of a dried PNGs electrode dried with an electrical field.

### DETAILED DESCRIPTION

### Example 1

### Catalyst Preparation

50 mg commercial graphene oxide obtained from Sigma Aldrich was added in 5 cc deionized water and sonicated for 60 min to disperse well. Afterwards, 33 mL Ammonia solution (25-28 wt % in water) was added and dispersed by conventional stirring. The solution was then transferred to a quartz tube to heat for 12 hours at 220° C. inside an oven. The synthesized powder of partially nitrogen-functionalized graphene oxide sheets (PNGs) was collected by centrifugation and desiccation at 80° C. overnight in, a vacuum oven to remove the physiosorbed NH₃.

Powder collected from the previous reaction step was mixed with nafion solution and ethanol to make a catalyst ink. To prepare the catalyst electrode for electrochemical measurements, 10 milligrams of the synthesized sample was mixed with the following solution: 1.25 mL ethanol solution and 50 μl Nafion (5 wt %). This solution was sonicated for 1 h to achieve homogenous ink.

The ink was then drop casted onto a glassy carbon electrode followed by the electrode being inserted between two AC electrodes. Specifically, a 10 μl drop of the catalyst ink was loaded onto the polished surface of the glassy carbon disk (d=5 mm) and dried slowly at room temperature to achieve a uniform surface. The drying of the electrode with PNGs occurred between two alternating current (AC) electrodes in an AC electric field. An AC voltage was supplied between 0 to 120 V using an AC voltage transformer with a constant frequency of 60 Hz using two parallel electrodes. The gap between the two AC electrodes was 1.5 mm. The electric field was applied until the catalyst ink was completely dry. Once the sample was completely dried, it was estimated that the amount of sample delivered to the surface was ˜400 μg/cm². As that phrase is used herein, “glassy carbon” references glass-like carbon material. The voltage regulating instrument used was a Variable AC Transformer 500VA Variac 0-130V TDGC2-0.5KVA.

A variety of other carbon nanostructures could be used in the methods disclosed herein including nitrogen functionalized carbon nano structures. Such nanostructures may include carbon nanotubes, nanoparticles, graphene, and others.

### Example 2

### Electrochemical Measurements

After the catalyst ink dried under the electric field, the interchangeable working electrode was then inserted into the electrode shaft of a rotating disk electrode measurement instrument, followed by measuring the electrochemical properties of electrocatalysts for oxygen reduction. A three-electrode electrochemical cell produced by Pine Research Instrumentation, USA and a potentiostat produced by A-METEC, USA were used for the tests. The fully prepared interchangeable electrode may be inserted in a rotating disk electrode measurement instrument for testing.

The sample was then used in electrochemical experiments immediately after drying. Finally, commercial catalyst 20 wt. % Pt/C was used as a comparison and prepared in the same way to achieve a similar loading of 400 μg/cm² of 20 wt % Pt/C (Pt loading: 80 μg/cm²). All measurements were carried out at room temperature using a potentiostat (A-METEC) with a three-electrode electrochemical cell. Rotating disk electrode measurements were performed on a Pine instrument produced by Pine Research Instrumentation, USA. A glassy carbon disk electrode with a 5 mm diameter was used as the working electrode, a platinum (Pt) wire as the counter electrode, and Hg/HgO (in KOH solution) as the reference electrode.

Linear sweep voltammetry measurements were performed in O₂-saturated 0.1 M KOH solution at a scan rate of 10 mVs⁻¹. The cyclic voltammetry experiments were conducted in O₂ and N₂-saturated 0.1 M KOH solution typically at, a scan rate of 50 mVs⁻¹. Rotating disk electrode measurements were performed at rotation rates of 1600 rpm, with the scan rate of 10 mVs⁻¹.

For applying an electric field using an AC voltage from 0 V to 120 V at room temperature, the glassy carbon electrode surface was facing the AC field electrodes with a spacing of 1.5 mm between the electrodes. For the sample exposed to the electric field by using 80 V, the electric field was 53.3 V/mm. That sample was designated as PNGs[53.3 V/mm], with the value in the rackets referring to the strength of the applied electric field.

### Example 3

### Differential Conductance

A computational method was implemented to calculate the differential conductance (dI/dV) of the sample from the electrochemical measurement data. A third order numerical differentiation method was used as follows,

$$\frac{dI}{dV} = \frac{( Δ {I}_{3} - 9 * Δ {I}_{2} + 45 * Δ {I}_{1} )}{60 * Δ V}$$

where

ΔI₁=I(V+h)−I(V−h)

ΔI₂=I(V+2h)−I(V−2h)

ΔI₃=I(V+3h)−I(V−3h)

and where h is the step size between the two data points of the potential in the calculation. The peaks of the differential conductance (10 S/m²) against the Potential V (vs. Hg/HgO) showed that the peaks of the PNGs[53.3 V/mm] were shifted toward the peak for platinum as compared to the graphene oxide sample and the PNGs[0 V/mm].

### Example 4

### Transmission Electron Microscopy

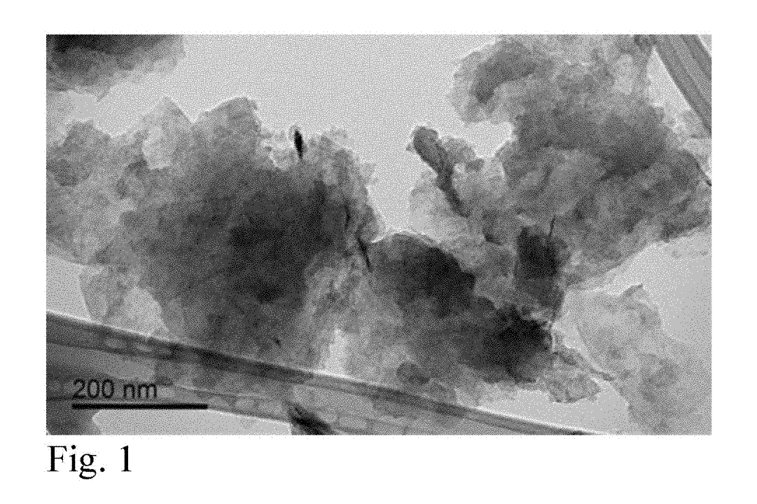

FIG. 1 shows the transmission electron microscopy image for the PNGs sample. The presence of graphene sheets in the sample after doping with nitrogen can be seen. For transmission electron microscopy studies, a drop of sonicated material suspension in ethanol was placed on a 3 mm copper grid, followed by drying under ambient conditions. FIG. 1 shows (a) transmission electron microscopy image of PNGs.

### Example 5

### X-Ray Photoelectron Spectrometer

A Kratos Axis 165 X-ray photoelectron spectrometer/Auger electron spectroscope were used to measure X-ray photoelectron spectrometer spectra. The samples were studied by the X-ray photoelectron spectrometer photo-electron spectroscopy using A1 Kα 1486.6 eV x-ray. High resolution spectra of C-1 s, N-1 s and O-1 s regions were collected on the samples. During data acquisition runs, a pass energy of 160 eV, current at 10 mA and a time of 20 ms per step were used.

A study on the presence of nitrogen after doping was performed by X-ray photoelectron spectrometer. X-ray photoelectron spectrometer spectra of C1 s binding energy (BE) range were shown indicating sp2 C (284.7 eV), sp3 C (284.9 eV), C—O/C—N (286.2 eV),π excitation (290.7 eV). The X-ray photoelectron spectrometer spectra of O1 s BE range shows O1: O—C (531.5 eV), O2: O═C (532.4 eV), O3: O—C═O (534.1 eV). The X-ray photoelectron spectrometer spectra of functionalized graphene were in the N1 s BE range. The X-ray photoelectron spectrometer spectra are fitted to get detailed chemical bonding information of the elements N and O with carbon. Nitrogen was observed in N-graphene, confirming its incorporation into graphene. Generally, there are several nitrogen functional groups in nitrogen-functionalized carbon.

These include pyridinic-N (N1, BE=396.1 eV), pyrrolic-N (N2, BE=400.2 eV), quaternary nitrogen (N3, BE=401.9 eV), and N-oxides of pyridinic-N (N4, BE=403.2 eV). The nitrogen functional groups are usually in the following molecular structures (chemical states): pyridinic-N refers to nitrogen atoms at the edge of graphene planes, each of which is bonded to two carbon atoms and donates one p-electron to the aromatic p system; pyrrolic-N refers to nitrogen atoms that are bonded to two carbon atoms and contribute to the p system with two p-electrons; quaternary nitrogen is also called “graphitic nitrogen” or “substituted nitrogen” in which nitrogen atoms are incorporated into the graphene layer and replace carbon atoms within a graphene plane; N-oxides of pyridinic-N (pyridinic-(N+-O)) are bonded to two carbon atoms and one oxygen atom. The role of the real “electrocatalytically active sites” is still controversial since their contribution to the catalytic activity is not well defined. In some studies, the enhanced electrocatalytic activity is attributed to pyridinic-N and/or pyrrolic-N. X-ray photoelectron spectrometer results indicated that N-graphene contains all these three functional groups (pyridinic-N, pyrrolic-N, and graphitic-N). Carbon atoms adjacent to nitrogen dopants may possess a substantially higher positive charge density to counterbalance the strong electronic affinity of the nitrogen atom, which results in an enhanced adsorption of O₂ and reactive intermediates (i.e., superoxide, hydroperoxide) that proceeds to accelerate the oxygen reduction reaction. The nitrogen-induced charge delocalization could also change the chemisorption mode of O₂ from monatomic end-on adsorption on undoped carbon to a diatomic side-on adsorption at nitrogen functionalized carbon which effectively weakens the O—O bond to facilitate the oxygen reduction reaction. This is also true for H₂O₂ reduction because breaking the O—O bond is also a key step for electrocatalytic reduction of H₂O₂. And the presence of nitrogen enhances the ability of graphene sheets to donate electrons, which is advantageous for reduction reactions.

### Example 7

### Scanning Electron Microscopy

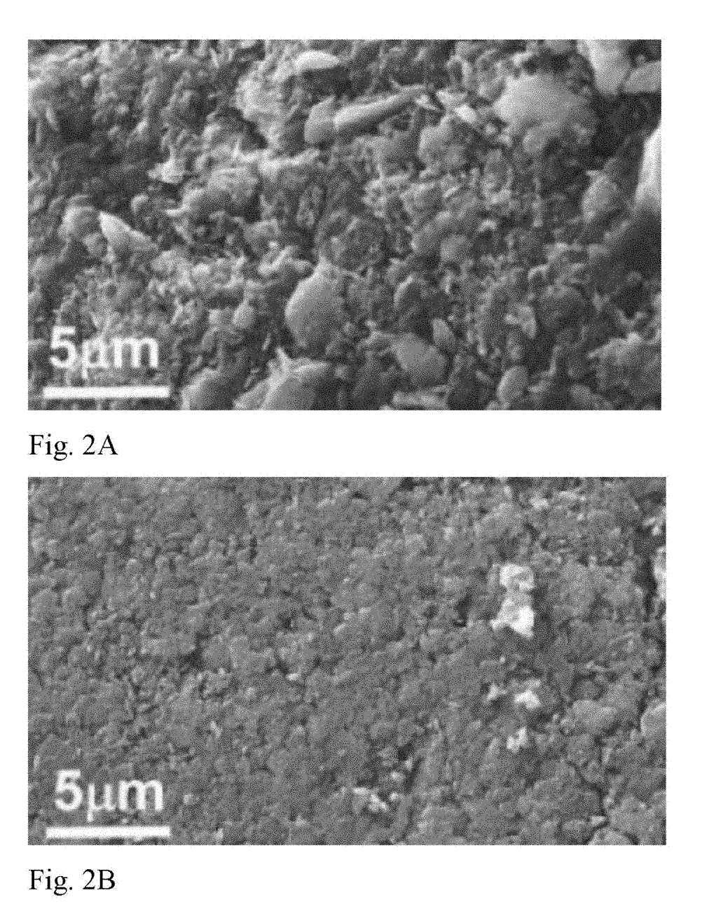

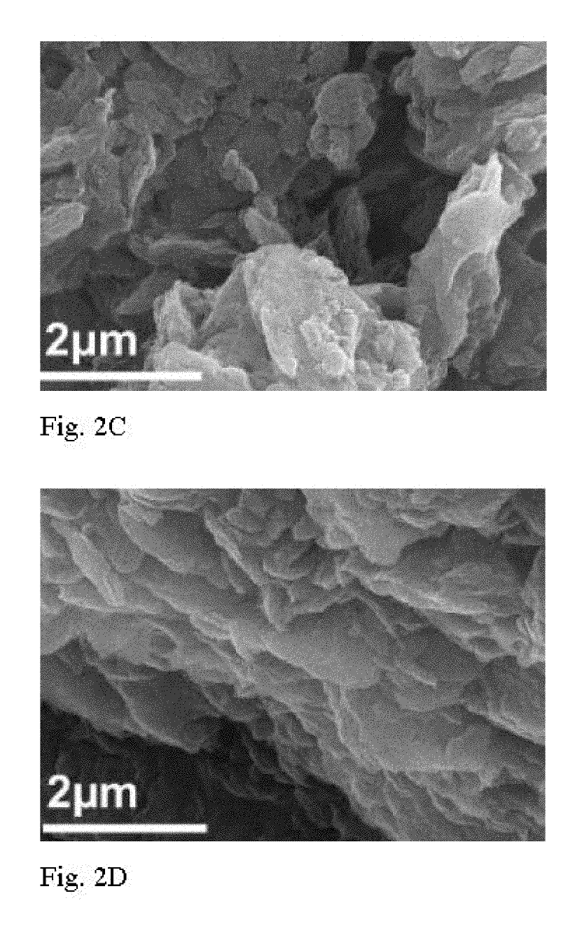

Scanning electron microscopy was employed to examine how electric filed can change the morphology of PNGs in the prepared electrocatalyst electrodes. FIG. 2A shows the results of drying of the catalyst ink on the electrode without the benefit of the AC electric field. FIG. 2B shows the alignment obtained by drying with the benefit of the AC electric field for PNGs[53.3 V/mm]. FIGS. 2C and 2D show cross sectional views of the PNGs without and with the benefit of the AC electric field respectively.

FIG. 2B shows the morphology of the PNGs after applying 80 V-AC, electric field. A smooth and homogeneous surface can be seen in that figure which can cause a uniform and compact surface with the electrode surface. The cross section scanning electron microscopy images indicate how the application of the electric field led to layered structures formed by PNGs aggregations, which parallel to each other. It is seen that PNGs were oriented with their flakes perpendicular to the electric field after applying the electric field. This observed result is different from the previous reported one for the graphene flakes in epoxy nanocomposites, which showed most of the graphene nanoplatelets (GnPs) are aligned very close to being parallel to the applied electric field direction. For all samples, scanning electron microscopy images were taken with (JSM-6610LV, JOEL. Japan, at voltage 15 kV) equipped with energy-disperse secondary analysis system (EDAX, USA). The microstructure of the samples was characterized by using transmission electron microscopy at 120 KV (JEM-1400, JEOL, Japan).

Applying an electric field to the PNGs in ethanol-Nation based ink induces the orientation of graphene sheets from a random state. In the presence of an electric field, each conductive PNGs undergoes a polarization. Several mechanisms influence the material: (a) electric dipoles induced on PNGs; (b) field-induced torque on the dipoles; (c) dipole-dipole attraction; and (d) spatial redistribution of PNGs in non-uniform applied field. The dipole moments induced on PNGs cause the sheets to rotate, orient and move towards each other. Nitrogen functionalized graphene sheets are decorated with oxygen and hydrogen groups from both sides. These groups with, different electronegativity on the graphene sheets have the tendency to be oriented along the electric field that induces polarized electric moments (dipoles). The polarization moments or dipoles p are generally not aligned with the electric field E. The polarization, moment can be divided into two contributing components, i.e., one parallel to the flake (p_{∥}) and one perpendicular to the flake (p_{⊥}). For N-functionalized graphene, the polarization moment perpendicular to the flake is much larger than that parallel to the flake due to the application of an electric field. This polarization moment leads to a field induced torque T acting on the flake which is given byT=p×E. In addition to electric field induced torque, Coulombic attraction is another force that acts on the graphite PNGs, which generated between the oppositely charged groups of different, graphene sheets. In addition, oriented PNGs cause inhomogeneities in the electric field. The non-uniform electric field in the vicinity of the graphene sheets results in the movement of induced dipoles towards the area with the highest strength, a behavior which is called dielectrophoresis. As a result, the polarized graphene sheets are able to migrate, rotate, orient, and move towards each other. The PNGs are stretched across, the electrodes to provide an enhanced conductivity throughout the sample due to the applied electric field.

### Oxygen Reduction Reaction Performance

Sample performance was compared for oxygen reduction reaction catalyses in alkaline media (0.1 M KOH) saturated in O₂ using linear sweep voltammetry. Comparing linear sweep voltammetry data of graphene oxide and. PNGs samples revealed that the presence of nitrogen can enhance the electrocatalytic performance, higher current density and more positive onset for PNGs compared to graphene oxide. A comparison of PNGs prepared under voltages of 0 V-AC, 20 V-AC, 40 V-AC, 60 V-AC, and 80 V-AC compared to 20 wt. % platinum on carbon catalyst showed that each successive increase in voltage for the preparation of the PNGs electrode resulted in a current density (mA/cm²) versus Potential (V) vs. Hg/HgO curve that was more similar to that of the 20 wt % platinum on carbon catalyst indicating the value of the electric field.

The electroactive surface area of PNGs [53.3 V/mm] and PNGs [0 V/min] were examined by studying the redox reactions involving Fe(CN)₆^{3-/4-} using the cyclic voltammetry measurements of two samples performed in 10 mM Fe(CN)₆^{3-/4-}/1 M KCl. The electroactive surface area were calculated based on the Randles-Sevcik equation which showed that PNGs[53.3 V/mm] had the greatest electroactive surface area followed by PNGs[0 V/mm] which was followed by plain graphene oxide which was greater than that of a bare glassy carbon electrode. The electroactive surface, area for PNGs[53.3 V/mm] was calculated as 0.975 cm², which is nearly two times higher than that for PNGs[0 V/min] at 0.756 cm². This indicates a strong enhancement of the effective electrode area.

After applying different AC-voltages from 0 to 80 V, linear sweep voltammetry data of the PNGs shows a very promissing inhancement after applying an 80 volt AC field with respect to onset potential and current density compared to a Pt/C electrode. The improvement of the onset potential around 0.2 V after applying AC electric field on PNGs (changing from −0.1 V for PNGs[0 V/mm] to 0.1 V after using PNGs[53.3 V/mm] is due to better conductivity of the sample.

The response of PNG sheets in an electric field is dominated by migration, rotation, orientation, and moving towards each other, due to the surface charges on the graphene sheets. The differential conductance calculated as the ratio of the current density in the material to the electric field that causes the flow of current. The polarization of the PNGs sheets allows for the manipulation of sheet orientation under the electrical field in the direction of the applied electric field in forming uniform and aligned sheets due to the more significant dielectrophoresis effect between the dispersed individual sheet that induced the rotation, orientation and movement towards the electrodes. An applied AC electric field could result in an increase of the induced force among the PNGs sheets and create a more conducting electrocatalytic electrode.

The Tafel equation describes the electrochemical kinetics relating to the rate of an electrochemical reaction to the overpotential. Larger Tafel slope indicates that a larger resistance (or a large loss of potential) is necessary to accelerate a chemical reaction. The sample PNGs[53.3 V/mm] exhibited Tafel slopes for oxygen reduction reaction comparable to those of PNGs[0 V/mm].

The durability of PNGs[53 V/mm] sample as an oxygen reduction reaction catalyst was also evaluated against PNGs[0 V/mm] electrode. The tests were performed using chronoamperometry in 0.1M KOH solution saturated with O₂. The corresponding current-time chronoamperometric response of PNGs[53.3 V/mm] exhibited a very slow attenuation with only a 13% reduction for the oxygen reduction reaction region and 26% reduction in the oxygen reduction reaction region over 8,000 seconds. By comparison, PNGs [0 V/mm] showed a much larger performance reduction.

The examples disclosed herein show a physical approach used to enhance the electrocatalytic perfonnance of anisotropic nano/micro structured electrocatalyst electrodes. The examples show that the electrocatalytic performance of nitrogen doped graphene nanosheets can be improved by using an electric field (AC or DC) to pole the catalyst powders during the fabrications of catalyst electrodes. This method can be used to enhance the electrocatalytic performance of nano/micro catalysts which possess some degree of anisotropy. The enhancement of the electrocatalytic performance of anisotropic nano/micro structured electrocatalysts in catalyst electrodes can also be achieved by using other methods such as by using a magnetic field or by employing mechanical stretching.

Electrocatalytic methods described herein may, for example comprise preparing a catalyst ink wherein the catalyst ink comprises a quantity of particles selected from a quantity of nano-structured electrocatalyst particles and a quantity of micro-structured electrocatalyst particles; casting the catalyst ink onto an electrode; drying the catalyst ink while subjecting the catalyst ink to an electrical field for a time sufficient to enhance the catalytic activity of the electrode and carrying out a chemical reaction in which the electrode acts as an electrocatalyst. In a related example, the quantity of particles may be a quantity of carbon nanoparticles. In a related example, the quantity of particles may be a quantity of carbon nanotubes. In a related example, the quantity of particles may be a quantity of carbon nanosheets. In a related example, the quantity of particles may be ,a quantity of graphene particles. In a related example, the quantity of particles may be a quantity of partially nitrogen functionalized graphene oxide sheets. In a related example, the quantity of particles may be nitrogen functionalized. In a related example, the electrical field may be an alternating current electrical field. In a related, example, the electrical field may be a direct current electrical field. In a related example, the drying of the catalyst ink while subjecting the catalyst ink to the electrical field may create an ordered layer of particles and the ordered layer of particles may be oriented parallel to a surface of the electrode. In a related example, the drying of the catalyst ink while subjecting the catalyst ink to the electrical field may create an ordered layer of particles and the ordered layer of particles may be oriented perpendicular to the electric field. In a related example, the chemical reaction may proceed at a first rate that is greater than a second rate wherein the second rate is the hypothetical rate of reaction that would have occurred had the electrical field not been applied. In a related example, the electrical field may be produced by a voltage of at least 80 volts. In a related example, the electrical field may be produced by a voltage of at least 50 volts. In a related example, the electrical field may be produced by a voltage of at least 35 volts. In a related example, the electrical field may have an electrical field strength of at least 50 V/mm. In a related example, the electrical field may have an electrical field strength of at least 35 V/mm. In a related example, the electrical field may have an electrical field strength of at least 25 V/mm. In a related example, the catalyst ink may comprise nafion. In a related example, the catalyst ink may contain an ionomer.

The above-described embodiments have a number of independently useful individual features that have particular utility when used in combination with one another including combinations of features from embodiments described separately. There are, of course, other alternate embodiments which are obvious from the foregoing descriptions, which are intended to be included within the scope of the present application

What is claimed is:

1. An electrocatalytic method comprising:
a. preparing a catalyst ink wherein the catalyst ink comprises a quantity of particles selected from a quantity of nano-structured electrocatalyst particles and a quantity of micro-structured electrocatalyst particles;
b. casting the catalyst ink onto an electrode;
c. drying the catalyst ink while subjecting the catalyst ink to an electrical field for a time sufficient to enhance the catalytic activity of the electrode and
d. carrying out a chemical reaction in which the electrode acts as an electrocatalyst.

2. The electrocatalytic method of claim 1 wherein the quantity of particles is a quantity of carbon nanoparticles.

3. ctrocatalytic method of claim 1 wherein the quantity of particles is a quantity of carbon nanotubes.

4. The electrocatalytic method of claim 1 wherein the quantity of particles is a quantity of carbon nanosheets.

5. The electrocatalytic method of claim 1 wherein the quantity of particles is a quantity of graphene particles.

6. The electrocatalytic method of claim 1 wherein the quantity of particles is a quantity of partially nitrogen functionalized graphene oxide sheets.

7. The electrocatalytic method of claim 1 wherein the quantity of particles is nitrogen functionalized.

8. ctrocatalytic method of claim 1 wherein the, electrical field is an alternating current electrical field.

9. The electrocatal method of claim 1 wherein the electrical field is a direct current electrical field.

10. The electrocatalytic method of claim 1 wherein the drying of the catalyst ink while subjecting the catalyst ink to the electrical field creates an ordered layer of particles and the ordered layer of particles are oriented parallel to a surface of the electrode.

11. The electrocatalytic method of claim 1 wherein the drying of the catalyst ink while subjecting the catalyst ink to the electrical field creates an ordered layer of particles and the ordered layer of particles are oriented perpendicular to the electric field.

12. The electrocatalytic method of claim 1 wherein the chemical reaction proceeds at a first rate that is greater than a second rate wherein the second rate is the hypothetical rate of reaction that would have occurred had the electrical field not been applied.

13. The electrocatalytic method of claim 1 wherein the electrical field is produced by a voltage of at least 80 volts.

14. The electrocatalytic method of claim 1 wherein the electrical field is produced by a voltage of at least 50 volts.

15. The electrocatalytic method of claim 1 wherein the electrical field, is produced by a voltage of at least 35 volts.

16. The electrocatalytic method of claim 1 wherein the electrical field has an electrical field strength of at least 50 V/mm.

17. The electrocatalytic method, of claim 1 wherein the electrical field has an electrical field strength of at least 35 V/mm.

18. The electrocatalytic method of claim 1 wherein the, electrical field has an electrical field strength of at least 25 V/mm.

19. The electrocatalytic method of claim 1 wherein the catalyst ink comprises nafion.

20. The electrocatalytic method of claim 1 wherein the catalyst ink comprises an ionomer.
